(19) United States
(12) Patent Application Publication
(10) Pub. No.: US 2008/0074549 A1
(43) Pub. Date: Mar. 27, 2008

(54) Double screen display picture output device

(75) Inventor: Yusuke Kumano, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/902,610

(22) Filed: Sep. 24, 2007

(30) Foreign Application Priority Data
Sep. 27, 2006 (JP) 2006-261913

(51) Int. Cl. H04N 5/445

(52) U.S. Cl. 348/564; 348/E05.099

(57) ABSTRACT

A double screen display picture output device that displays a first screen and a second screen simultaneously on a display device with changing the screen ratio freely includes: a screen ratio setting unit that sets a screen ratio between the first screen and the second screen; a screen ratio calculating unit that calculates the screen ratio between the first screen and the second screen in response to the setting of the screen ratio setting unit; and a picture composition processing portion that displays the first picture signal to be displayed on the first screen and the second picture signal to be displayed on the second screen as the first screen and the second screen having sizes satisfying the screen ratio on the display device.

This application is based on Japanese Patent Application No. 2006-261913 filed on Sep. 27, 2006, and the contents of which are hereby incorporated by reference.

### BACKGROUND OF THE INVENTION

1. Field of the Invention

The present invention relates to a picture output device. In particular, the present invention relates to a double screen display picture output device such as a television set, a navigation device or the like, which is equipped with a display device and has a double screen display function that is capable of displaying a first screen and a second screen simultaneously.

2. Description of Related Art

Conventionally, some picture output devices such as a television set, a navigation device or the like equipped with a display device have a double screen display function that is capable of displaying a first screen and a second screen simultaneously.

As this type of double screen display picture output device, for example, the conventional device disclosed in JP-A-2006-14004 can display selectively between a double screen mode 1 and a double screen mode 2 by pressing a screen mode button of a remote controller. In the former mode, a first screen and a second screen are displayed as two screens having the same size. In the latter mode, the first screen is displayed in a large size, and the second screen is displayed in a small size.

In addition, the conventional device disclosed in PCT WO98/20303 displays two split screens side by side, which is switched among a twin mode in which the two split screens has the same size, a left main mode in which the left split screen has a larger size and a right main mode in which the right split screen has a larger size, in response to an operation of a mode switch of the remote controller.

However, although the conventional device disclosed in JP-A-2006-14004 displays selectively the double screen mode 1 in which the first screen and the second screen are displayed as two screens having the same size, or the double screen mode 2 in which the first screen is displayed in a large size while the second screen is displayed in a small size by pressing the screen mode button of the remote controller, it is unable to set a ratio of screen size freely between the first screen and the second screen. Therefore, it does not have good usability for a user who wants to change the ratio of screen size (hereinafter referred to as a “screen ratio”) between the two screens. Furthermore, although the conventional device disclosed in PCT WO98/20303 displays two split screens side by side, which is switched among a twin mode in which the two split screens has the same size, a left main mode in which the left split screen has a larger size and a right main mode in which the right split screen has a larger size, in response to an operation of a mode switch of the remote controller, this conventional device is also does not have good usability for a user who wants to change the screen ratio between the two screens.

### SUMMARY OF THE INVENTION

The present invention is made in view of the above described problem and it is an object of the present invention to provide a double screen display picture output device that can change the screen ratio between two screens freely.

To attain the above described object a double screen display picture output device that displays a first screen and a second screen simultaneously on a display device in accordance with a first aspect of the present invention includes: a screen ratio setting unit that sets a screen ratio between the first screen and the second screen; a screen ratio calculating unit that calculates the screen ratio between the first screen and the second screen in response to the setting of the screen ratio setting unit; and a picture composition processing portion that displays the first picture signal to be displayed on the first screen and the second picture signal to be displayed on the second screen as the first screen and the second screen having sizes satisfying the screen ratio on the display device.

In this structure, a screen ratio between the first screen and the second screen is calculated by the screen ratio calculating unit in response to the setting of the screen ratio setting unit. The first picture signal to be displayed as the first screen and the second picture signal to be displayed as the second screen are displayed on the display device as the first screen and the second screen having sizes satisfying the screen ratio by the picture composition processing portion.

According to this structure, the size ratio between two screens can be changed freely, easily and intuitively by operating the screen ratio setting unit. Thus, a limited screen size of the display device can be used effectively, so usability is improved for a user who wants to change the screen ratio between the two screens.

A double screen display picture output device in accordance with a second aspect of the present invention is characterized by that the screen ratio setting unit is a slide switch that has a structure in which an output voltage thereof alters when a slide lever thereof is moved, and a relative position of the slide lever in the slide switch corresponds to the screen ratio in the double screen display picture output device according to the above described first aspect. As a result, because the screen ratio setting unit is realized by utilizing the slide switch and the relative position of the slide lever in the slide switch corresponds to the screen ratio, the size ratio between two screens can be changed freely, easily and intuitively.

A double screen display picture output device in accordance with a third aspect of the present invention is characterized by that the relative position of the slide lever is made to correspond to the screen ratio by: a first screen size voltage detecting unit that detects the output voltage of the slide switch as a first screen size voltage for controlling a size of the first screen; a voltage difference detecting unit that detects a voltage difference between an input voltage to the slide switch and the output voltage; a second screen size voltage detecting unit that detects the voltage difference as a second screen size voltage for controlling a size of the second screen; and the screen ratio calculating unit that calculates the screen ratio between the first screen and the second screen based on the first screen size voltage and the second screen size voltage in the double screen display picture output device according to the above described second aspect. As a result, because the a first screen size voltage for controlling a size of the first screen and a second screen size voltage for controlling a size of the second screen are detected based on the output voltage of the slide switch, the screen ratio between the first screen and the second screen can be calculated by the first screen size voltage and the second screen size voltage.

A double screen display picture output device in accordance with a fourth aspect of the present invention includes: a slide switch provided to a main body operating portion and/or a remote controller for setting a screen ratio between the first screen and the second screen, having a structure in which its output voltage alters when a slide lever is moved; a first screen size voltage detecting unit that detects the output voltage of the slide switch as a first screen size voltage for controlling a size of the first screen; a voltage difference detecting unit that detects a voltage difference between an input voltage of the slide switch and the output voltage; a second screen size voltage detecting unit that detects the voltage difference as a second screen size voltage for controlling a size of the second screen; and a screen ratio calculating unit that calculates a screen ratio between the first screen and the second screen based on the first screen size voltage and the second screen size voltage.

In this structure, the output voltage of the slide switch corresponds to the first screen size voltage and is supplied to the first screen size voltage detecting unit. In addition, the output voltage is supplied to the voltage difference detecting unit, so that a voltage is calculated by subtracting output voltage from the input voltage of the slide switch. Since this calculated voltage corresponds to the second screen size voltage, this second screen size voltage is supplied to the second screen size voltage detecting unit. The first screen size voltage in this case is detected by the first screen size voltage detecting unit, and the second screen size voltage is detected by the second screen size voltage detecting unit. Next, the screen ratio calculating unit calculates the screen ratio based on the voltage difference between the first screen size voltage from the first screen size voltage detecting unit and the second screen size voltage from the second screen size voltage detecting unit. Then, the picture composition processing portion sets the size of the first screen and the size of the second screen based on the calculate screen ratio, so that the set two screens are displayed on the display device.

According to this structure, it becomes possible to change the ratio of sizes of two screens freely, easily and intuitively by operating the slide switch. Thus, a limited screen size of the display device can be used effectively, so usability is improved for a user who wants to change the screen ratio between the two screens.

As above described because a double screen display picture output device that displays a first screen and a second screen simultaneously on a display device in accordance with a first aspect of the present invention includes: a screen ratio setting unit that sets a screen ratio between the first screen and the second screen; a screen ratio calculating unit that calculates the screen ratio between the first screen and the second screen in response to the setting of the screen ratio setting unit; and a picture composition processing portion that displays the first picture signal to be displayed on the first screen and the second picture signal to be displayed on the second screen as the first screen and the second screen having sizes satisfying the screen ratio on the display device, the size ratio between two screens can be changed freely, easily and intuitively by operating the screen ratio setting unit. Thus, a limited screen size of the display device can be used effectively, so usability is improved for a user who wants to change the screen ratio between the two screens.

In addition, because a double screen display picture output device in accordance with a fourth aspect of the present invention includes: a slide switch provided to a main body operating portion and/or a remote controller for setting a screen ratio between the first screen and the second screen, having a structure in which its output voltage alters when a slide lever is moved; a first screen size voltage detecting unit that detects the output voltage of the slide switch as a first screen size voltage for controlling a size of the first screen; a voltage difference detecting unit that detects a voltage difference between an input voltage of the slide switch and the output voltage; a second screen size voltage detecting unit that detects the voltage difference as a second screen size voltage for controlling a size of the second screen; and a screen ratio calculating unit that calculates a screen ratio between the first screen and the second screen based on the first screen size voltage and the second screen size voltage, it becomes possible to change the ratio of sizes of two screens freely, easily and intuitively by operating the slide switch. Thus, a limited screen size of the display device can be used effectively, so usability is improved for a user who wants to change the screen ratio between the two screens.

### BRIEF DESCRIPTION OF THE DRAWINGS

FIG. 1 is a block diagram to show a structure of a television set including a double screen display picture output device according to one embodiment of the present invention.

FIG. 2 is a block diagram to show an example of a structure of a screen size control portion and its peripheral elements in the embodiment.

FIG. 3 is a diagram of one example of a display screen for explaining screen sizes of a first screen and a second screen that are displayed on a display device in the present embodiment.

FIG. 4 is a diagram of another example of a display screen for explaining screen sizes of the first screen and the second screen that are displayed on the display device in the present embodiment.

FIG. 5 is a flowchart for explaining operations of changing sizes of the first screen and the second screen in the present embodiment.

### DETAILED DESCRIPTION OF THE PREFERRED EMBODIMENTS

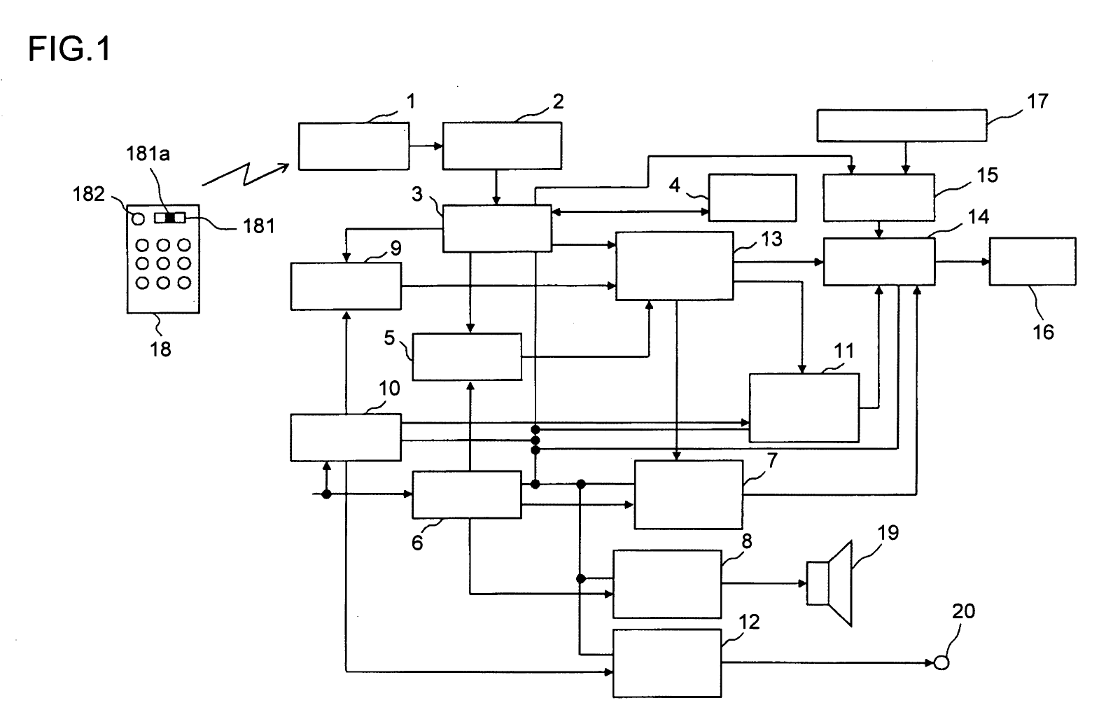

Hereinafter, embodiments of the present invention will be described with reference to the attached drawings. FIG. 1 is a block diagram to show a structure of a television set including a double screen display picture output device according to an embodiment of the present invention.

As shown in FIG. 1, the television set is provided with a first screen tuner 6 that receives a picture and audio signal from an antenna, a second screen tuner 10 that receives a picture and audio signal from the antenna, a first screen audio signal processing portion 8 that processes an audio signal from the first screen tuner 6 and delivers the processed signal to a speaker 19, a second screen audio signal processing portion 12 that processes an audio signal from the second screen tuner 10 and delivers the processed signal to an earphone terminal 20, a first screen caption control portion 5 that obtains caption data from the picture signal delivered from the first screen tuner 6, a second screen caption control portion 9 that obtains caption data from the picture signal delivered from the second screen tuner 10, an on-screen display processing portion 13 that converts the caption data delivered by the first screen caption control portion 5 and the second screen caption control portion 9 into an on-screen signal, a first screen picture signal processing portion 7 that processes a picture signal from the first screen tuner 6 and the on-screen signal from the on-screen display processing portion 13, a second screen picture signal processing portion 11 that processes the picture signal from the second screen tuner 10 and the on-screen signal from the on-screen display processing portion 13.

In addition, this television set is provided with a picture composition processing portion 14 that combines the picture signal from the first screen picture signal processing portion 7, the picture signal from the second screen picture signal processing portion 11, and the on-screen signal from the on-screen display processing portion 13, a screen size control portion 15 that controls the picture composition processing portion 14 so as to change a ratio of screen sizes between the first screen and the second screen in response to an operation of a main body slide switch 17 or an operation of a slide switch 181 on a remote controller 18, a display device 16 that receives a picture signal from the picture composition processing portion 14 and displays the picture, a television control portion 3 that controls the television set, a remote controller code decoding portion 1 that decodes a code transmitted from the remote controller 18, an event managing portion 2 that decides an event delivered from the remote controller code decoding portion 1 and issues an instruction to the television control portion 3, and a memory 4 that stores a current state mode.

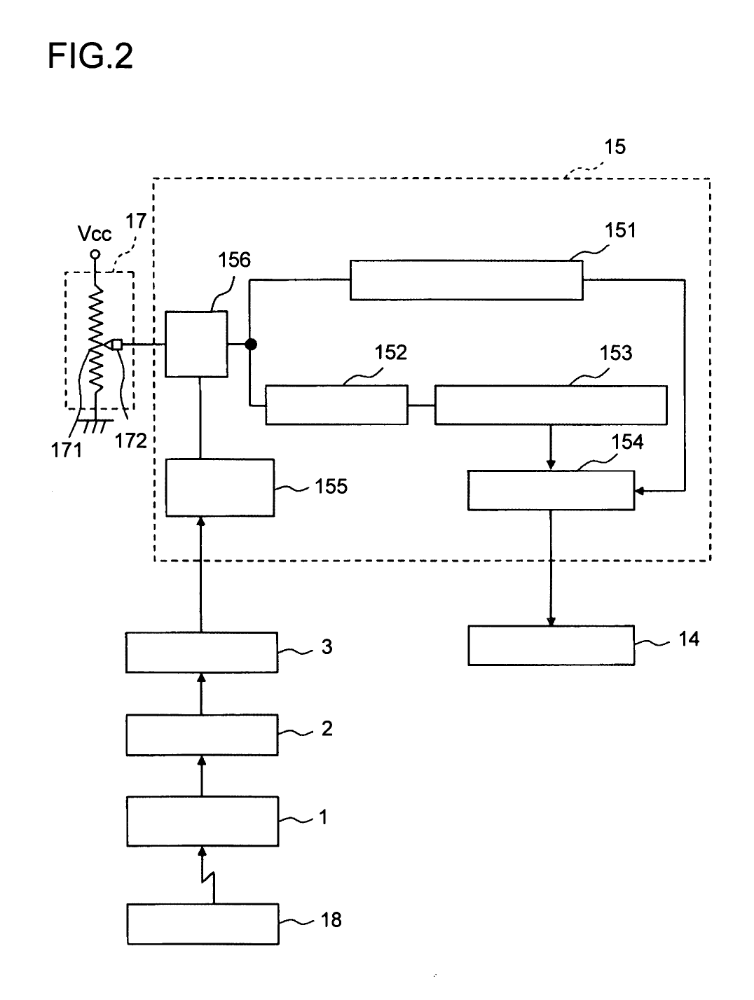

FIG. 2 is a block diagram to show an example of a structure of the screen size control portion and its peripheral elements in the present embodiment. As shown in FIG. 2, the screen size control portion 15 includes a first screen size voltage detecting unit 151, a voltage difference detecting unit 152, a second screen size voltage detecting unit 153, a screen ratio calculating unit 154, a slide voltage output unit 155, and a switching unit 156. The main body slide switch (i.e., a screen ratio setting unit) 17 has a resistor 171 and a slide contact 172. One end of the resistor 171 is supplied with a power source voltage Vcc, while the other end of the resistor 171 is connected to the ground. The slide contact 172 moves to slide on the resistor 171, and an output voltage of the slide contact 172 alters when the slide contact 172 is moved. The switching unit 156, which selects one of the output of the slide contact 172 and the output of the slide voltage output unit 155. It selects the slide contact 172 when the output voltage of the slide contact 172 alters and selects the slide voltage output unit 155 when the output voltage of the slide voltage output unit 155 alters. In other words, when the main body slide switch 17 is operated, the switching unit 156 selects the output of the slide contact 172; when the slide switch 181 (i.e., a slide lever 181a) of the remote controller 18 is operated, the switching unit 156 selects the output of the slide voltage output unit 155.

The first screen size voltage detecting unit 151 detects an output voltage of the switching unit 156 as a voltage for setting a size of the first screen. For example, it is supposed that the power source voltage Vcc is 10 volts, for plain description. Then, if the slide contact 172 of the main body slide switch 17 is positioned at the medium position of the resistor 171, the output voltage of the slide contact 172 is 5 volts, which is supplied to the first screen size voltage detecting unit 151 via the switching unit 156. Thus, the first screen size voltage detecting unit 151 detects 5 volts as the first screen size voltage.

On the other hand, the voltage of 5 volts delivered from the switching unit 156 is supplied to the voltage difference detecting unit 152. The voltage difference detecting unit 152 compares the voltage of 5 volts with the power source voltage Vcc (10 volts in the case of this example) that is a reference voltage, and a voltage of 5 volts is delivered as a difference between them. Thus, the second screen size voltage detecting unit 153 detects 5 volts as the second screen size voltage. In this case, therefore, the screen ratio calculating unit 154 calculates the ratio 1:1 between the first screen size and the second screen size in response to the voltage difference between them. Then, this ratio 1:1 is supplied to the picture composition processing portion 14, and the picture composition processing portion 14 sets the ratio between the screen size of the first screen picture signal from the first screen picture signal processing portion 7 and the screen size of the second screen picture signal from the second screen picture signal processing portion 11 to 1:1. Thus, the first screen and the second screen are displayed on the display device 16 with the screen size ratio of 1:1.

Furthermore, if the slide contact 172 of the main body slide switch 17 is positioned at the point of 1:4 viewed from the power source voltage Vcc (10 volts) side of the resistor 171, the output voltage of the slide contact 172 becomes 8 volts. This voltage of 8 volts is supplied to the first screen size voltage detecting unit 151 via the switching unit 156. Thus, the first screen size voltage detecting unit 151 detects 8 volts as the first screen size voltage.

On the other hand, the voltage of 8 volts delivered from the switching unit 156 is supplied to the voltage difference detecting unit 152. The voltage difference detecting unit 152 compares the voltage of 8 volts with the power source voltage Vcc (10 volts in the case of this example) that is a reference voltage, and a voltage of 2 volts is delivered as a difference between them. Thus, the second screen size voltage detecting unit 153 detects 2 volts as the second screen size voltage. In this case, therefore, the screen ratio calculating unit 154 calculates the ratio 4:1 between the first screen size and the second screen size in response to the voltage difference between them. Then, this ratio 4:1 is supplied to the picture composition processing portion 14, and the picture composition processing portion 14 sets the ratio between the screen size of the first screen picture signal from the first screen picture signal processing portion 7 and the screen size of the second screen picture signal from the second screen picture signal processing portion 11 to 4:1. Thus, the first screen and the second screen are displayed on the display device 16 with the screen size ratio of 4:1.

If the user operates the slide switch 181 of the remote controller 18, a remote controller code indicating a set position of the slide switch 181 is decoded by the remote controller code decoding portion 1, and further an event of the remote controller code is decided by the event managing portion 2. Then, an instruction corresponding to the event is issued to the television control portion 3. Thus, the television control portion 3 controls the slide voltage output unit 155 so that the slide voltage output unit 155 delivers a slide voltage corresponding to the set position of the slide switch 181 of the remote controller 18.

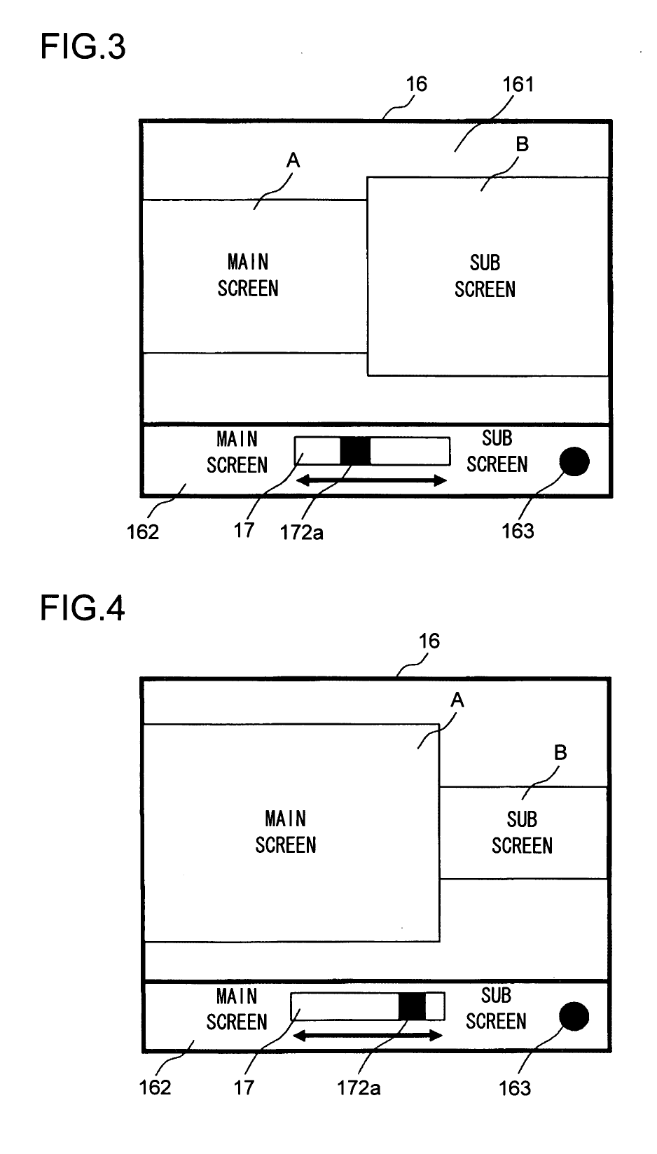

In other words, the television control portion 3 makes a slide switch voltage unit 155 deliver a voltage corresponding to the slide voltage delivered from the slide contact 172 of the main body slide switch 17 described above. On this case, the switching unit 156 selects the slide voltage output unit 155. The succeeding actions are the same as the actions in the case where the main body slide switch 17 is operated, so descriptions thereof will be omitted. Although the slide switch 181 such as the main body slide switch 17 (see FIG. 3) is provided to the remote controller 18 in the above description, it is possible to another structure in which if one of two particular operational buttons is held in the pressed state, the same action is performed as the case when the main body slide switch 17 is moved in the right direction, while if the other operational button is held in the pressed state, the same action is performed as the case when the main body slide switch 17 is moved in the left direction.

FIGS. 3 and 4 are diagrams of examples of display screens for explaining screen sizes of the first screen and the second screen that are displayed on the display device in the present embodiment.

In FIGS. 3 and 4, a first screen A and a second screen B are displayed on the display screen 161 of the display device 16. In addition, a main body operating portion 162 of the display device 16 is provided with a slide switch 17, a power source switch 163 and the like. A slide lever 172a of the slide switch 17 is ganged with the slide contact 172 (see FIG. 2). When the slide lever 172a is moved horizontally, the slide contact 172 moves to slide on the resistor 171 (see FIG. 2) so that the output voltage of the slide contact 172 alters.

Therefore, if the slide lever 172a is set to the left side position as shown in FIG. 3, a size of the first screen A is smaller than a size of the second screen B. In addition, if the slide lever 172a is set to the right side position as shown in FIG. 4, a size of the first screen A is larger than a size of the second screen B. In addition, if the slide lever 172a is set to the middle position (not shown), a size of the first screen A is the same as a size of the second screen B. Moreover, if the slide lever 172a is set to the left end position (not shown), the first screen A is not displayed while the second screen B is displayed in the whole area of the display screen 161. Moreover, if the slide lever 172a is set to the right end position (not shown), the second screen B is not displayed while the first screen A is displayed in the whole area of the display screen 161.

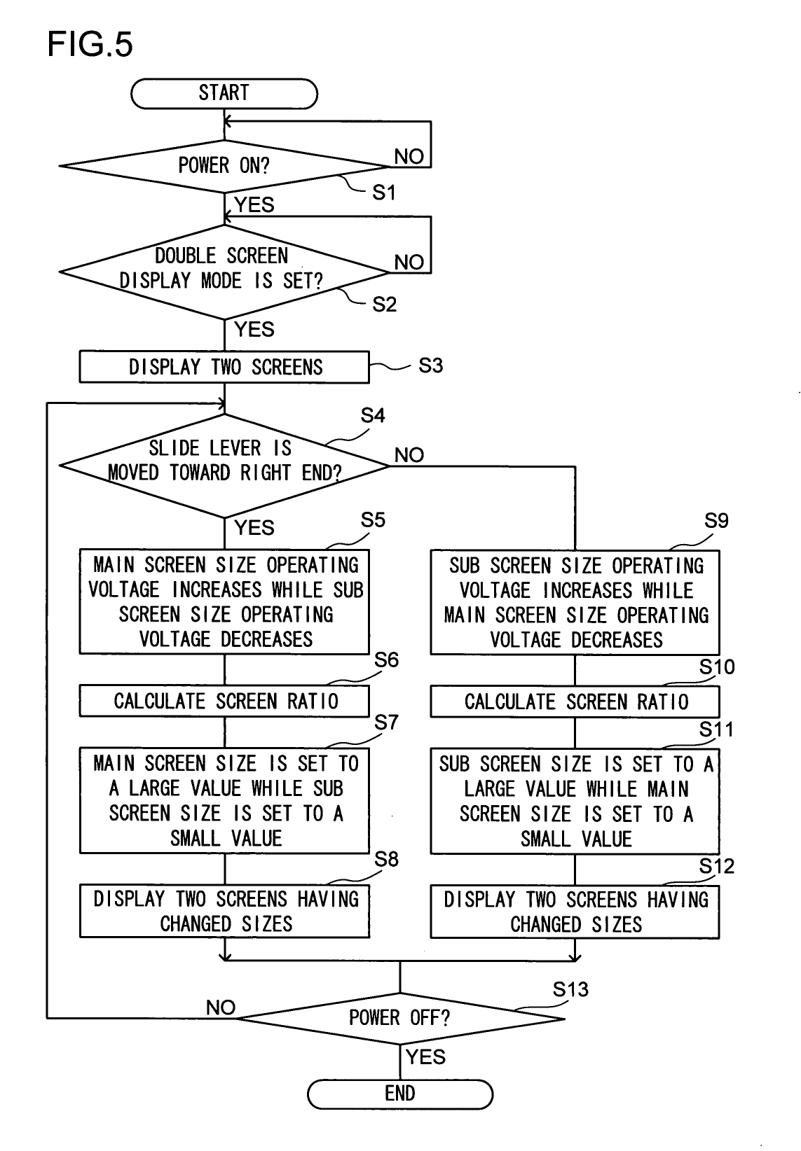

FIG. 5 is a flowchart for explaining an action of changing sizes of the first screen and the second screen in the present embodiment. The action of changing sizes of the first screen and the second screen will be described with reference to this flowchart and FIGS. 1-4.

When a power key 182 of the remote controller 18 or a power key 163 of the main body operating portion 162 is pressed, the television control portion 3 detects that the device is powered on (step S1). Furthermore, when the television control portion 3 detects that a double screen display mode is set by operation of the remote controller 18 (step S2), it makes the display device 16 display two screens (step S3). In this case, a ratio of the screen size between a first screen A and a second screen B displayed on the display device 16 is corresponding to a position of the slide lever 172a of the main body slide switch 17. This size ratio (screen ratio) is described above with reference to FIGS. 3 and 4.

When the user slides the slide lever 172a of the slide switch 17 toward the right end (step S4), the output voltage of the slide contact 172 of the slide switch 17 increases. The output voltage corresponds to the first screen size voltage, which is supplied to the first screen size voltage detecting unit 151 via the switching unit 156. In addition, the output voltage thereof is supplied to the voltage difference detecting unit 152 via the switching unit 156, and a voltage is calculated by subtracting the output voltage from the power source voltage Vcc. This calculated voltage corresponds to the second screen size voltage, and this second screen size voltage is supplied to the second screen size voltage detecting unit 153. In other words, the first screen size voltage is increased while the second screen size voltage is decreased (step S5). The first screen size voltage in this case is detected by the first screen size voltage detecting unit 151, and the second screen size voltage is detected by the second screen size voltage detecting unit 153.

Next, the screen size control portion 15 calculates the screen ratio based on a voltage difference between the first screen size voltage from the first screen size voltage detecting unit 151 and the second screen size voltage from the second screen size voltage detecting unit 153 (step S6). Then, the picture composition processing portion 14 sets the size of the first screen A of the first screen picture signal from the first screen picture signal processing portion 7 and the size of the second screen B of the second screen picture signal from the second screen picture signal processing portion 11 based on the calculated screen ratio. In this case, the size of the first screen A is set to a large value, while the size of the second screen B is set to a small value (step S7), and the two screens having the changed sizes are displayed on the display device 16 (step S8).

On the other hand, in the step S4, if the user moves the slide lever 172a of the slide switch 17 to slide toward the left end in (step S4), the output voltage of the slide contact 172 of the slide switch 17 becomes low. The output voltage corresponds to the first screen size voltage and is supplied to the first screen size voltage detecting unit 151 via the switching unit 156. In addition, the output voltage is supplied to the voltage difference detecting unit 152 via the switching unit 156, so that a voltage is calculated by subtracting the output voltage from the power source voltage Vcc. This calculated voltage corresponds to the second screen size voltage, and this second screen size voltage is supplied to the second screen size voltage detecting unit 153. In other words, the first screen size voltage is decreased while the second screen size voltage is increased (step S9). The first screen size voltage in this case is detected by the first screen size voltage detecting unit 151 while the second screen size voltage is detected by the second screen size voltage detecting unit 153.

Next, the screen size control portion 15 calculates the screen ratio based on the voltage difference between the first screen size voltage from the first screen size voltage detecting unit 151 and the second screen size voltage from the second screen size voltage detecting unit 153 (step S10). Then, the picture composition processing portion 14 sets the size of the first screen A of the first screen picture signal from the first screen picture signal processing portion 7 and the size of the second screen B of the second screen picture signal from the second screen picture signal processing portion 11 based on the calculated screen ratio. In this case, the size of the second screen B is set to a large value while the size of the first screen A is set to a small value (step S11), so that the two screens having the changed size are displayed on the display device 16 (step S12).

As described above, according to the present embodiment, the size ratio between two screens can be changed freely, easily and intuitively by operating the slide switch. Thus, a limited screen size of the display device can be used effectively, so usability is improved for a user who wants to change the screen ratio between the two screens.

Although the structure of the television set including the double screen display picture output device having the feature of the present invention is explained in the embodiment described above, the present invention is not limited to this structure but can be applied to any structure of a navigation device or other electronic equipment that displays two screens. In addition, although the first screen is a screen of the first screen picture signal from the first screen tuner and the second screen is a screen of the second screen picture signal from the second screen tuner in the present invention, the present invention is not limited to this structure. In general, it can be regarded that the first screen is a first screen of the first screen picture signal while the second screen is a screen of the second screen picture signal. For example, the first screen picture signal may be a picture signal of a television broadcasting while the second screen picture signal may be a picture signal of a navigation device. In this case, a picture of the television broadcasting program is displayed on the first screen, and a picture signal of the navigation device is displayed on the second screen. It is possible to exchange the first screen and the second screen.

The present invention can be applied to a double screen display picture output device that is provided with a display device, such as a television set or a navigation device, so that a ratio of sizes of two screens can be changed freely.

What is claimed is:

1. A double screen display picture output device that displays a first screen and a second screen simultaneously on a display device, the device comprising:
a screen ratio setting unit that sets a screen ratio between the first screen and the second screen;
a screen ratio calculating unit that calculates the screen ratio between the first screen and the second screen in response to the setting of the screen ratio setting unit; and
a picture composition processing portion that displays the first picture signal to be displayed on the first screen and the second picture signal to be displayed on the second screen as the first screen and the second screen having sizes satisfying the screen ratio on the display device.

2. The double screen display picture output device according to claim 1, wherein the screen ratio setting unit is a slide switch that has a structure in which an output voltage thereof alters when a slide lever thereof is moved, and a relative position of the slide lever in the slide switch corresponds to the screen ratio.

3. The double screen display picture output device according to claim 2, wherein the relative position of the slide lever is made to correspond to the screen ratio by
a first screen size voltage detecting unit that detects the output voltage of the slide switch as a first screen size voltage for controlling a size of the first screen,
a voltage difference detecting unit that detects a voltage difference between an input voltage to the slide switch and the output voltage,
a second screen size voltage detecting unit that detects the voltage difference as a second screen size voltage for controlling a size of the second screen, and
the screen ratio calculating unit that calculates the screen ratio between the first screen and the second screen based on the first screen size voltage and the second screen size voltage.

4. A double screen display picture output device that displays a first screen and a second screen simultaneously on a display device, the device comprising:
a slide switch provided to a main body operating portion and/or a remote controller for setting a screen ratio between the first screen and the second screen, having a structure in which its output voltage alters when a slide lever is moved;
a first screen size voltage detecting unit that detects the output voltage of the slide switch as a first screen size voltage for controlling a size of the first screen;
a voltage difference detecting unit that detects a voltage difference between an input voltage of the slide switch and the output voltage;
a second screen size voltage detecting unit that detects the voltage difference as a second screen size voltage for controlling a size of the second screen; and
a screen ratio calculating unit that calculates a screen ratio between the first screen and the second screen based on the first screen size voltage and the second screen size voltage.
